(19) United States
(12) Patent Application Publication
(10) Pub. No.: US 2017/0021202 A1
(43) Pub. Date: Jan. 26, 2017

(54) SYSTEM COMPRISING A CLOSED-CIRCUIT RESPIRATOR AND A MONITORING DEVICE THEREFOR

(71) Applicant: Dräger Safety AG & Co. KGaA, Lübeck (DE)

(72) Inventors: Jochim KOCH, Ratzeburg (DE); Jörg POLZIEN, Ratzeburg (DE)

(21) Appl. No.: 15/039,648

(22) PCT Filed: Nov. 27, 2014
(86) PCT No.: PCT/EP2014/003179

§ 371 Date: May 26, 2016

(30) Foreign Application Priority Data
Nov. 30, 2013 (DE) 10 2013 020 098.9

(51) Int. Cl. A62B 9/00; A62B 9/02; A62B 7/02; A62B 18/02; A62B 19/00

(52) U.S. Cl. CPC A62B 9/006; A62B 18/02; A62B 19/00; A62B 7/02; A62B 9/02; A62B 9/003

(57) ABSTRACT

A system includes a closed-circuit respirator (1) with a breathing mask (2), a closed breathing circuit, which leads from the breathing mask via an exhalation tube (3), a lime cartridge (4) for binding CO₂, a spring-loaded breathing bag (5) and an inhalation tube (7) to the breathing mask. A pressurized oxygen tank (11) is connected to the circuit via a constant dispensing unit (8) and to the breathing bag via a minimum flow control valve (9), which opens upon a collapse of the breathing bag (lack of breathing gas in the circuit) and fills the breathing bag from the oxygen tank. A pressure sensor (12) detects the pressure in the oxygen tank. A constant dispensing unit introduces oxygen with a volume lower than a mean oxygen volume demand. A monitoring device (13-15) calculates a quantity of oxygen consumed and still remaining from the detected pressure and an initial pressure value.

### CROSS REFERENCE TO RELATED APPLICATIONS

This application is a United States National Phase Application of International Application PCT/EP2014/003179 filed Nov. 27, 2014 and claims the benefit of priority under 35 U.S.C. §119 of German Application 10 2013 020 098.9 filed Nov. 30, 2013 the entire contents of which are incorporated herein by reference.

### FIELD OF THE INVENTION

The present invention pertains to a system comprising a closed-circuit respirator and a monitoring device therefor, wherein the closed-circuit respirator has a breathing mask, a closed breathing circuit, which leads from the breathing mask via an exhalation tube, a breathing lime cartridge for binding CO₂, a spring-loaded breathing bag and an inhalation tube back to the breathing mask, an oxygen tank containing pressurized oxygen, which is connected to the closed breathing circuit via a constant dispensing valve and to the breathing bag via a minimum flow control valve, wherein the minimum flow control valve is set up to open in response to a collapse of the breathing bag based on lack of breathing gas in the closed breathing circuit and thus to fill the breathing bag with oxygen from the oxygen tank until it is filled up, and a pressure sensor for detecting the pressure in the oxygen tank.

### BACKGROUND OF THE INVENTION

Closed-circuit respirators are respirators operating independently from the ambient atmosphere. There are used routinely where hazards must be expected due to toxic pollutants in the breathing air or to oxygen deficiency.

Freely portable closed-circuit respirators supply the respirator user with breathing gas, which is produced and purified in the device. The carbon dioxide exhaled by the respirator user is sent with the breathing gas in the closed breathing circuit through a breathing lime cartridge, in which the carbon dioxide is reacted by a chemical reaction and is thus removed from the breathing gas. Oxygen is additionally fed continuously from an oxygen tank. Oxygen is dispensed at a constant rate in prior-art devices with a volume flow of approx. 1.6 L/minute. This constant dispensing is necessary to supply an average respiratory minute volume of about 30 L/minute with a sufficient quantity of oxygen. Further, a breathing bag, through which the breathing gas flows, is present in the closed breathing circuit. When the respirator user has a higher respiratory minute volume due to increased strain, the excess breathing gas demand is covered from the breathing bag, which is loaded with a spring and collapses as a result as the amount of breathing gas removed increases. The consequence of the collapse of the breathing bag is that a minimum flow control valve connected thereto is opened, and oxygen is then sent through this valve from the oxygen tank with a high volume flow into the breathing bag in order to refill this. The minimum flow control valve closes again during the filling of the breathing bag. If the respirator user is in a situation of rest and the oxygen consumption is much lower than about 1.6 L/minute which is being dispensed constantly, breathing gas volume is released via a pressure relief valve, which is actuated by the expanded breathing bag. However, this is not efficient, because unused oxygen is lost to the ambient atmosphere as a result, and this is no longer available for the user of the closed-circuit respirator and thus reduces the theoretically possible maximum service life. In addition, the nitrogen originally present is flushed out, as a consequence of which the oxygen concentration increases.

Since the beginnings of the use of closed-circuit respirators, these have been equipped with a pressure gauge for the pressure in the oxygen tank, so that the user must calculate himself/herself for how long the user can still perform the mission and whether the user still has a sufficient oxygen reserve for his return. More modern monitoring devices with mobile data transmission systems are capable of calculating from the amount of oxygen consumed and the elapsed time when the mission must be interrupted to retreat with a still sufficient reserve. These times are presented to the head of operations on a monitor. A prior-art device indicates the pressure in the oxygen tank and calculates the probably remaining residual use time on the basis of the pressure drop.

A respirator suitable for overpressure operation is described in DE 32 29 240 A1. An overpressure, which is set by the pressure in the gas bottle in an indirect manner by means of a defined force, is generated in the closed breathing circuit. The force is transmitted by a piston-and-cylinder unit.

A so-called self-contained breathing apparatus (SCBA) is described in US 2006/0201508 A1. All available parameters, which occur during the operation, are converted by an electronic analysis unit into a factor, which indicates the available remaining time during the mission. This solution makes possible an indication concerning the service life for land- or water-based systems.

DE 26 41 579 A1 describes a device for monitoring a respirator, wherein the consumption of the breathing gas is detected and can be communicated from the person using the device to other persons via a radiotelephone communication.

It happens in many applications that the respirator user has a markedly lower oxygen demand than the fixed preset value of 1.6 L/minute, but in case of a preset quantity of 400 L of oxygen in the oxygen tank, this nevertheless leads to a limitation of the duration of use to about 250 minutes because the quantity of breathing lime is selected according to the quantity of oxygen being carried along. This quantity of breathing lime carried along is so large enough to bind the CO₂ formed when the total amount of oxygen carried along is consumed. There are scenarios during the mission, especially in emergencies, in which the respirator user may be at risk and the rescuer must wait to be rescued because of an injury or due to being trapped, for example, in a mine, and requires relatively little oxygen because of low physical strain; a longer service life would be urgently necessary in such cases.

### SUMMARY OF THE INVENTION

An object of the present invention is to configure a closed-circuit respirator with a monitoring device such that a longer use time is possible and, associated with it, the present necessary indication of how much oxygen has already been consumed or of how much oxygen is still available for a further use time is provided.

According to the invention, a system is provided comprising a closed-circuit respirator and a monitoring device therefor. The closed-circuit respirator comprises a breathing mask, a closed breathing circuit, which leads from the breathing mask via an exhalation tube, a breathing lime cartridge for binding CO₂, a spring-loaded breathing bag and an inhalation tube leading back to the breathing mask. An oxygen tank (also known as an oxygen bottle) containing pressurized oxygen, is connected to the closed breathing circuit via a constant dispensing unit is connected to the breathing bag via a minimum flow control valve. The minimum flow control valve is set up to open in response to a collapse of the breathing bag because of lack of breathing gas in the closed breathing circuit and thus to fill the breathing bag with oxygen from the oxygen tank until the breathing bag is filled. A pressure sensor detects the pressure in the oxygen tank. The constant dispensing unit is configured to introduce oxygen into the closed breathing circuit with a low basic volume flow, which is lower than the mean oxygen volume demand of an unstressed person. The monitoring device is configured to calculate the quantity of oxygen consumed by breathing by the user of the device and the quantity of oxygen still remaining in the oxygen tank from the current pressure value delivered by the pressure sensor and the initial pressure value of the pressurized oxygen in the oxygen tank at the beginning of use.

Provisions are made according to the present invention for the constant dispensing unit to be configured to introduce oxygen with a low basic volume flow that is lower than the mean oxygen volume demand of an unstressed person into the closed breathing circuit. It is ensured hereby that no phases with oversupply of oxygen, which would then have to be released, as before, unused into the surrounding area, will occur during the use. The low, constant basic volume flow is rather so low that oxygen must occasionally be introduced into the breathing bag via the minimum flow control valve, depending on the stress situation of the respirator user; the basic volume flow may even be zero in the extreme case (oxygen is fed in this case into the breathing bag during certain phases via the minimum flow control valve only). In any case, it is thus ensured that all the oxygen that is taken from the oxygen tank is respirated by the respirator user. The monitoring device is configured to calculate the quantity of oxygen consumed by respiration by the respirator user or the quantity of the oxygen still left in the oxygen tank, which latter quantity results therefrom, from the pressure of the pressurized oxygen in the oxygen tank, which pressure is supplied by the pressure sensor, and from the initial pressure valve of the pressurized oxygen at the beginning of the use. It is possible due to this configuration of the closed-circuit respirator and the monitoring device to make do with markedly less than the constant dispensing volume flow of 1.6 L/minute used in the state of the art during phases with relatively low strain, as a result of which a longer service life is possible for many use scenarios. At the same time, the respirator user or the head of operations is informed by the monitoring device of the actual oxygen consumption and the residual oxygen capacity resulting therefrom in the oxygen tank.

If, for example, the filling pressure of the oxygen tank P1 is 200 bar at an ambient pressure P0 of 1 bar and the volume of the oxygen tank is V_{Bottle}=2 L,

ΔV_{Bottle}=(1−P2/P)·V_{Bottle}=0.8 L

is obtained for the consumed bottle volume in case of a drop in the pressure in the oxygen tank during the use to a pressure P2 of 120 bar.

At a filling pressure P1 of 200 bar and an ambient pressure P0 of 1 bar,

VO2s=V_{Bottle}·P1/P0=400 L

is obtained for the stored oxygen volume.

If the pressure in the oxygen tank has dropped to the valve P2=120 bar after a use time, the remaining residual volume in the bottle, VO₂r, will be

VO2r=VO2s·P2/P0=240 L.

The oxygen volume respirated by the respirator user is:

ΔVO₂=VO2s−VO2r=400 L−240 L=160 L.

The respirated respiratory minute volume is:

Vv=ΔVO₂·AMV/VO2=160 L×30 L/minute/1.45 L/minute=3.310 L,

where VO2 is the percentage of consumed oxygen per minute at the respiratory minute volume (AMV=30 L/minute), which equals 1.45 L/minute.

Regardless of the respiration rate of the respirator user and his actual tidal volume (stroke volume), his respiratory minute volume can be calculated from his real oxygen consumption, because the constant dispensing is so low that it is always lower than the actual oxygen consumption. The excess consumption is then supplied by the minimum flow control valve. The constant dispensing may also be set, in principle, at 0, so that oxygen is fed into the breathing bag and hence into the closed breathing circuit via the minimum flow control valve only and the oxygen is fed “according to the demand.”

With the systems known hitherto with a minimum dispensing rate of 1.6 L/minute, the respirator user inhales in the first minutes a breathing gas whose oxygen concentration, equaling 40% to 60%, is substantially higher than in the ambient air (21 vol. % of O₂). As soon as the user consumes less than about 1.6 L/minute, the system is filled and the breathing bag expands to the extent that it actuates the pressure relief valve. This leads to an increasing quantity of the nitrogen present in the breathing gas mixture to be flushed out and to the oxygen concentration increasing in the direction of 100 vol. %. If constant dispensing is not employed, the situation will develop on very rare occasions that excess breathing gas must be released from the closed circuit, with the advantage that the respirator user inhales a breathing gas mixture with a considerable percentage of nitrogen for a long time. The nitrogen can then only be flushed out due to a leak on the device or at the mask, but this can be greatly minimized by a leak test at the beginning of use. By abandoning fixed dispensing, it is therefore possible to breath in a closed circuit with a low oxygen concentration for a considerably longer time than in case of conventional closed-circuit respirators dispensing at a constant rate from the oxygen tank.

In a preferred embodiment, the monitoring device is configured to calculate a current oxygen consumption per unit of time from the volume curve of the oxygen consumed, A VO₂ (t) as a function of time, from the slope of said curve. In a preferred embodiment, the monitoring device may be configured to calculate a predicted remaining service life from this current oxygen consumption and the determined quantity of oxygen still left in the oxygen tank.

In a preferred embodiment, the monitoring device is configured to compare the basic volume flow of oxygen with the current oxygen consumption and if the basic volume flow is not lower than the current oxygen consumption by a preset threshold criterion, to lower the basic volume flow by acting on the constant dispensing unit. The monitoring device may be set up for this, for example, to reduce the basic volume flow until the threshold criterion is met if the basic volume flow is not lower than the current oxygen consumption by at least 20%.

The monitoring device is set up in a preferred embodiment to calculate the work performed by the user of the device, Q (t)=Q₀·ΔVO₂ (t) (in which Q₀ is a physiological parameter, determined in advance, of an energy equivalent with a value of about 20.2 kJ/L (O₂)) or the metabolic output from the volume of oxygen consumed by the respirator user during the mission, ΔVO₂(t) up to a time t. A Respiratory Quotient RQ of 0.82 (Schmidt/Tews, Physiologie des Menschen [Human Physiology], Springer Verlag) corresponds to an energy equivalent of Q₀=20.2 kJ per L of O₂.

In the example already used above, in which 160 L of oxygen are consumed, this will then correspond to a work of

Q=Q₀·ΔVO₂=20.2 kJ/L·160 L=3.232 kJ.

This corresponds to an average metabolic output of Pₘₑₜₐ=Q/t=3.232 kJ/100 minutes=449 W.

If the efficiency between the metabolic output and the mechanical output is η=25%, the respirator user had a mechanical, physical output of P_{mech}=Pₘₑₜₐ·η=449 W 25%=112 W. In a preferred embodiment, the monitoring device is configured to calculate the mechanical output of the respirator user from the metabolic output delivered up to a point in time.

The metabolic output minus the mechanical output is introduced into the body in the form of thermal output and it directly increases the body temperature, which may lead, if physiological limit values, for example, 39° C., are exceeded, to considerable physiological problems and even to circulatory collapse or collapse. An indication of this thermal stress can be established by this simple calculation. The body temperature of a respirator user, which is really present, cannot, of course, be calculated here individually, because they depend, among other things, on the environmental conditions, clothing and body weight of the user. It may, however, be a good indicator that the respirator user is delivering a high physical output and the user loses his performance capacity due to an increase in body temperature and the loss of water and electrolytes. The loss of electrolytes and water can be counteracted if a breathing mask with a drinking connection is used.

The monitoring device is set up in a preferred embodiment to calculate from the volume of the oxygen consumed by the respirator user during the use up to a time t, ΔVO₂ (t), the volume of CO₂ produced by the respirator user up to that time, VCO₂ (t)=RQ·ΔVO₂ (t), where RQ as a respiratory equivalent is an empirical factor determined in advance. The CO₂ production can thus also be calculated from the pressure drop in the oxygen tank and the consumption of absorber lime, which accompanies such CO₂ production, can be calculated as well. It is thus possible to indirectly indicate the consumption of the capacity of the breathing lime cartridge.

In case of Central European diet, the respiratory quotient is RQ=0.82, i.e., the volume of CO₂ produced can be calculated from the consumed oxygen volume with this factor:

VCO₂(t)=RQ·ΔVO₂(t).

In the example already mentioned above, the following volume of CO₂ was produced if 160 L of oxygen had been produced up to the time t:

VCO₂(t)=0.82·160 L=131 L.

This CO₂ volume produced was absorbed by the breathing lime. The monitoring device is therefore preferably configured to calculate from the volume of CO₂ produced by the respirator used up to a time t, VCO₂ (t), the quantity of breathing lime consumed up to that time to bind this volume of CO₂ or to calculate the quantity of breathing lime still remaining in the breathing lime cartridge thereafter.

The breathing lime (essentially calcium hydroxide, Ca(OH)₂) has a weight of 2.6 kg in this example, and it converts the CO₂ into calcium carbonate CaCO₂ and water H₂O according to the following stoichiometric formula:

Ca(OH)₂+CO₂=CaCO₃+H₂O.

The absorption capacity of 2.6 kg of breathing lime corresponds to approx. 180 L of CO₂. With each L of oxygen consumed, 0.82 L of CO₂ are bound in the breathing lime, and a similar residual capacity calculation can thus be set up for the breathing lime as for the oxygen. The quantity of CO₂ formed from 400 L of O₂ equals approx. 330 L. The Drager breathing lime for closed-circuit devices theoretically binds approx. 266 L of CO₂ per kg. The CO₂-binding capacity of the Drager CO₂ absorber from a prior-art device containing approx. 2.6 kg of breathing lime accordingly equals a maximum of 692 L of CO₂, i.e., twice as much as the quantity produced during the metabolism of 400 L of O₂. The efficiency of the Drager CO₂ absorber equals, depending on the rate of respiration, approx. 65%-75% (450 L 520 L of CO₂), the residual safety reserve being used to compensate losses of capacity occurring during storage and under extreme climatic conditions (especially cold).

In a preferred embodiment, the monitoring device is configured to perform the calculations of consumed oxygen ΔVO₂(t), of the work performed Q(t), of the carbon dioxide produced VCO₂(t) or of the quantity of breathing lime consumed over the entire duration of use up to the present time t as a whole, over continuous partial intervals up to the time t repeatedly or continuously in real time as current values.

In a preferred embodiment, a breathing gas cooler, which cools the breathing gas heated in the breathing lime cartridge by the chemical reactions taking place in it, is present in the closed breathing circuit downstream of the breathing lime cartridges and in front of the breathing mask in the direction in which the breathing gas circulates. The breathing gas cooler may have, for example, a reserve of ice in heat-conducting contact with the breathing gas line or a reserve of another phase-changing material, which absorbs heat from the surrounding area during the phase change and thus cools the surrounding area; blower type coolers are also known as an alternative as breathing gas coolers.

In a preferred embodiment, the monitoring device is configured to calculate a physiological strain rate of the respirator user from current values of the oxygen consumption of the respirator user or from values of the oxygen consumption of the respirator user averaged over a time interval reaching the current point in time or from values derived therefrom for carbon dioxide production or respiratory minute volume by relating the current value to a corresponding 100% value of the short-term performance capacity of persons in good physical condition, which 100% value was determined in advance.

If the individual respirator user is known to have maximum physiological performance capacity, for example, through the indication of his maximum CO₂ production, which is measured on an ergometer or a treadmill for about 3 minutes until exhaustion under maximum physical exertion, the extent to which he is strained can then be derived therefrom with the calculated CO₂ production. Mean values of persons in average physical condition may otherwise be used.

It is known from many ergonomic studies that a physically fit person can be strained with about 45% to 55% of his maximum CO₂ production for a rather long time without becoming exhausted in the short term. Physically fit persons, such as firemen and mine rescue team members, have, for example, a CO₂ value of MaxCO₂=4.1 L/minute of CO₂. This corresponds to a maximum oxygen consumption of MaxO₂=MaxCO₂/RQ, which in this example yields:

MaxO₂=MaxCO₂RQ=4.1 L/minute/0.82=5 L/minute O₂.

This would correspond to a maximum respiratory minute volume of MaxAMV=30 L/minute AMV/1.45 L/minute O₂·5 L/minute O₂=103 L/minute. This maximum tidal volume MaxAMV corresponds to 100% of his short-term performance capacity shortly before exhaustion.

At a respiratory minute volume of 30 L/minute, he would have a physiological strain rate PB of

PB=100%/MaxAMV·AMV=29%,

which is consequently still below his reasonable continuous physiological strain. More a physiological strain rate PB of 55% on a scale of 0 to 10 the maximum value, 29% correspond to a value of 5.3.

The Physiological Strain Index (PSI), which likewise uses a scale from 0 to 10, is known from physiological studies. Values between 5 and 6 are considered to be moderate, 7 to 8 high and 9 to 10 very high. This scale can thus be used and thus indicated to the head of operations how highly the respirator user is physiologically strained. If the scales are provided, for example, with colors, as in the case of a traffic light, the range of 0 to 4 could be displayed in green, that from 5 to 8 as yellow and above 8 as red, so that the information is easily detectable for the head of operations. The physiological strain rate PB with the value of 5.3 would have the yellow color in the above-mentioned example.

High physiological strains are accompanied by a high metabolic heat production in the body and by the risk of heat exhaustion, a limitation of the performance capacity and dehydration due to intense sweating. The physiological strain and the risk of hyperthermia can also be estimated relatively well with the detection of oxygen consumption, etc., which is possible with the systems according to the present invention. With a body weight of 85 kg (95-percentile man) and a metabolic output of 449 W and a mechanical output of 110 W, a person produces at least an output of 337 W, which remains in the body in the form of heat. Without considering the heat losses to the surrounding area, it is certainly impossible to accurately determine the body temperature in this way, but valuable information is made available, which indicates the thermal stress of the respirator user and points out the fact that increased core temperature is to be expected, especially if the mission lasts longer and the surrounding area has high temperatures and humidities.

This physiological strain can still be corrected by including the ambient temperature. For example, the rise in body temperature is markedly lower at a low ambient temperature than at a high ambient temperature. The ambient humidity, which greatly affects the increase in the core temperature, may be included as well. Another influencing variable is the thermal property of the clothing, which can nowadays be determined very accurately by ISO 7730 in respect to its heat and moisture permeability. A heat-insulating and moisture-permeable clothing leads to a higher body temperature under equal physical strain than a clothing with good heat dissipation that is permeable to moisture. By simply measuring the ambient conditions and taking into account the clothing parameters, which are known for certain occupational groups (such as firemen, mine workers, industrial workers, etc.), the physiological load-bearing capacity can be adapted as well. For example, the physiological strain rate PB of 55% can thus be increased at a lower ambient temperature by a certain amount because the user can be stressed for a longer time and his body temperature rises more slowly. A temperature sensor, optionally also a humidity sensor, would detect the ambient conditions in the embodiment. An additional input for the properties of the clothing could also take this function into account.

Accordingly, sensors are present in a preferred embodiment for detecting the ambient temperature and/or the ambient humidity. The monitoring device is configured to include the ambient temperature and/or the ambient humidity in the calculation of the physiological strain rate.

Further, the monitoring device is set up according to a preferred embodiment to keep information on the clothing of the respirator user in respect to heat permeability and/or moisture permeability stored in order to then include it in the calculation of the physiological strain rate.

In a preferred embodiment, the monitoring device is configured to have information on the presence of a breathing gas cooler and optionally on the cooling capacity thereof ready in a stored form. If no breathing gas cooler is present, the information concerning the breathing gas cooling is restricted to the information that no breathing gas cooler is present. If the information concerning the breathing gas cooling contains that a breathing gas cooler is present, information on the cooling capacity of said breathing gas cooler may optionally be stored; such information may include information concerning the overall cooling capacity, concerning the transport thermal energy per unit of time or the still remaining cooling capacity. Such information on breathing gas cooling may be included by the monitoring device in the calculation of the physiological strain rate.

In a preferred embodiment, the monitoring device is integrated in the closed-circuit respirator. The closed-circuit respirator is now provided with displays in order to inform the respirator user concerning oxygen consumption, carbon dioxide production or breathing lime consumption. The displays may comprise optical, acoustic or tactile display units. In case of the monitoring device integrated in the closed-circuit respirator, the closed-circuit respirator is be provided, furthermore, with wireless transmission units, which transmit the results of the monitoring device to a remotely located receiver, for example, a mission central command

As an alternative the monitoring device may be a device separate from the closed-circuit respirator, in which case the closed-circuit respirator is provided with a radio device, which is connected to the pressure sensor and with which the pressure values of the pressurized oxygen in the oxygen tank can be transmitted to the remotely located monitoring device.

The present invention is described in detail below with reference to the attached figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 shows a schematic block diagram of a closed-circuit respirator with monitoring device.

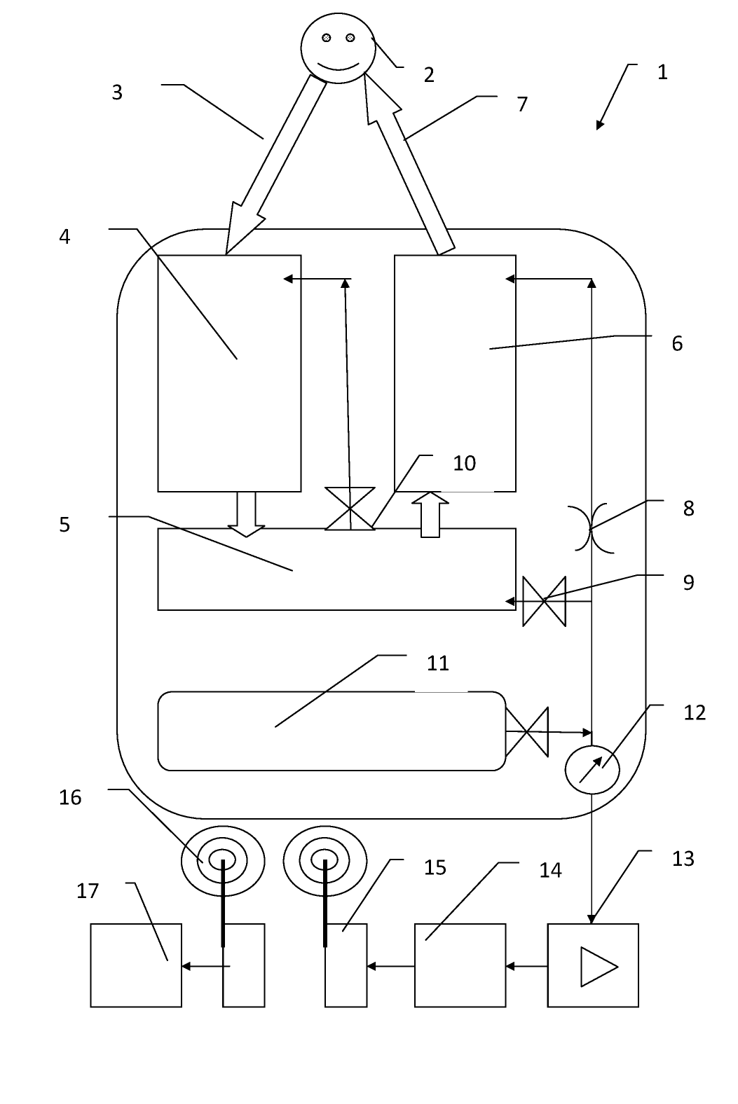

### DESCRIPTION OF THE PREFERRED EMBODIMENTS

Referring to the drawings, the closed-circuit respirator 1 with the monitoring device has a breathing mask 2, from which the closed breathing circuit leads farther first through an exhalation tube 3 to a breathing lime cartridge 4 as a CO₂ absorber. The counter-lung is established by means of a spring-loaded breathing bag 5 and the breathing gas flows through the breathing bag 5 and farther to a breathing gas cooler 6, in which the breathing gas heated in the breathing lime cartridge 4 is cooled again. The closed breathing circuit then closes via an inhalation tube 7, which leads back to the breathing mask 2. The breathing gas cooler may be present, as it is in this exemplary embodiment, but it is not necessary for the present invention.

Oxygen is dispensed constantly in the inhalation line via a constant dispensing unit 8. If the quantity of oxygen fed is not sufficient or breathing gas is lost due to leakage, the spring-loaded breathing bag 5 collapses and actuates a minimum flow control valve 9, which makes oxygen available with a high volume flow and rapidly refills the breathing bag 5. If less oxygen is consumed than is fed via the constant dispensing unit 8, the breathing bag 5 is filled to a greater extent and presses against a maximum flow control valve 10, which releases excess breathing gas into the surrounding area in front of the breathing lime cartridge. However, the constant dispensing unit is set up in the system according to the present invention such that the oxygen volume flow being fed is below the oxygen consumption of an unstressed person with certainty, so that more oxygen must be sent from time to time into the breathing bag 5 via the minimum flow control valve in order to feed a sufficient quantity of oxygen. It is thus ensured in any case that the oxygen fed from the oxygen tank 11 will be respirated and not released into the surrounding area.

The constant dispensing unit 8 and the minimum flow control valve 9 are supplied from the oxygen tank 11, which is connected to a pressure sensor 12.

The monitoring device is composed of the components with the reference numbers 13 through 15. The measured values of the pressure sensor 12 are recorded in an analysis unit 13 over time and the time curve of the oxygen consumption is calculated from this. Different data, such as, e.g., the current oxygen pressure, current oxygen consumption and remaining available service life at constant consumption, can be displayed via a display 14. The data can be sent to the mission command via a radio unit 15 and received there in a receiving unit 16 and displayed in an analysis unit 17. The current pressures, current oxygen consumption and remaining available use time can likewise be displayed in the analysis unit 17 in the mission command. These values may also be represented in the form of trends. In addition, important indications of the physiological and thermal stress of the respirator user can also be communicated there to the head of operations, for example, in the form of a traffic light. For example, the physical strain may be displayed with a color code (traffic light). The light is green in case of a low physiological strain, yellow at medium strain and red at high strain, when this mission must be expected to lead to a high thermal stress or even to exhaustion and the mission must be interrupted and the respirator user must leave the hazardous area. All these represent important pieces of information for both the respirator user himself/herself and for the responsible head of operations. This information can be detected with the system according to the present invention, because the total amount of oxygen released from the oxygen tank 11 into the closed breathing circuit is respirated in this system and the quantity of respirated oxygen can thus be detected by measuring the pressure drop and can be calculated, and further data, such as CO₂ production, breathing lime consumption, etc., can then be derived from this.

While specific embodiments of the invention have been shown and described in detail to illustrate the application of the principles of the invention, it will be understood that the invention may be embodied otherwise without departing from such principles.

1. A system comprising:
a closed-circuit respirator and a monitoring device therefor, the closed-circuit respirator comprising:
a breathing mask;
an exhalation tube;
an inhalation tube;
a closed breathing circuit connected to the breathing mask via the exhalation tube and the inhalation tube, the breathing circuit having a breathing lime cartridge for binding CO₂, a spring-loaded breathing bag;
an oxygen tank containing pressurized oxygen;
a constant dispensing unit, the oxygen tank being connected to the closed breathing circuit via the constant dispensing unit;
a minimum flow control valve, the oxygen tank being connected to the breathing bag via a minimum flow control valve, wherein the minimum flow control valve is configured to open in response to a collapse of the breathing bag because of lack of breathing gas in the closed breathing circuit and to fill the breathing bag with oxygen from the oxygen tank until the breathing bag is filled; and
a pressure sensor for detecting the pressure in the oxygen tank, wherein the constant dispensing unit is configured to introduce oxygen into the closed breathing circuit with a low basic volume flow, which is lower than a mean oxygen volume demand of an unstressed person, and the monitoring device is configured to calculate a quantity of oxygen consumed by breathing by the user of the device and a quantity of oxygen still remaining in the oxygen tank from a current pressure value delivered by the pressure sensor and an initial pressure value of the pressurized oxygen in the oxygen tank at a beginning of use.

2. A system in accordance with claim 1, wherein the monitoring device is configured to calculate a current oxygen consumption per unit of time from the volume curve of the oxygen consumed—ΔVO₂(t)—the change in oxygen volume as a function of time, from the slope of said curve.

3. A system in accordance with claim 2, wherein the monitoring device is configured to calculate a predicted remaining service life from the current oxygen consumption and the quantity of oxygen still remaining in the oxygen tank.

4. A system in accordance with claim 2, wherein the monitoring device is configured to compare the basic volume flow with the current oxygen consumption and to reduce the basic volume flow by acting on the constant dispensing unit when the basic volume flow is not lower than the current oxygen consumption by a preset threshold criterion.

5. A system in accordance with claim 1, wherein the monitoring device is configured to calculate the work performed by the user of the device, Q(t)=Q₀·ΔVO₂(t) (wherein Q₀ is a physiological parameter, determined in advance, of an energy equivalent with a value of about 20.2 kJ/L(O₂)) or the metabolic output performed from the volume of the oxygen consumed by the respirator user during the mission, ΔVO₂(t) up to a time t.

6. A system in accordance with claim 5, wherein the monitoring device is configured to calculate the mechanical output performed by the respirator user from the metabolic output performed up to a point in time.

7. A system in accordance with claim 1, wherein the monitoring device is configured to calculate from the volume of the oxygen consumed by the respirator user during the mission up to a time t the volume of CO₂ produced by the respirator user up to that time, VCO₂(t)=RQ·ΔVO2(t), wherein RQ, as a respiratory equivalent, is a factor determined empirically in advance.

8. A system in accordance with claim 7, wherein the monitoring device is configured to calculate from a CO₂ volume produced by the respirator user up to a time t, VCO₂(t), the quantity of breathing lime consumed up to that time for binding this volume of CO₂ or the quantity of breathing lime still remaining thereafter in the breathing lime cartridge.

9. A system in accordance with claim 5, wherein the monitoring device is configured to perform the calculations of consumed oxygen ΔVO₂(t), the work performed Q(t), the carbon dioxide produced VCO₂(t) or the quantity of breathing lime consumed over the entire mission up to the current time t as a whole over continuous partial time intervals up to the time t repeatedly, or continuously in real time as current values.

10. A system in accordance with claim 1, further comprising a breathing gas cooler in the closed breathing circuit upstream of the breathing lime cartridge and in front of the breathing mask.

11. A system in accordance with claim 1, wherein the monitoring device is configured to calculate a physiological strain rate of the respirator user from current values of the oxygen consumption of the respirator user or from values of the oxygen consumption of the respirator user averaged over a time interval reaching up to the current time or from values for carbon dioxide production or respiratory minute volume, which values were derived therefrom.

12. A system in accordance with claim 11, wherein the monitoring device is configured to calculate the physiological strain rate of the respirator user from current values of the oxygen consumption of the respirator user or from values of the oxygen consumption of the respirator user which were averaged over a time interval reaching up to the current time or from values derived therefrom for carbon dioxide production or respiratory minute volume by relating the current value to the corresponding 100% of short-term performance capacity of persons in good physical condition, which 100% value was determined in advance.

13. A system in accordance with claim 11, further comprising sensors for detecting ambient temperature or ambient humidity or both ambient temperature and ambient humidity and wherein the monitoring device is configured to include the detected ambient temperature or the ambient humidity or both the ambient temperature and the ambient humidity in the calculation of the physiological strain rate.

14. A system in accordance with claim 11, wherein the monitoring device is configured to have information on the clothing of the respirator user concerning heat or moisture permeability or both heat and moisture permeability ready in the stored form and the monitoring device is configured to include the information pertaining to the clothing concerning heat or moisture permeability or both heat and moisture permeability in the calculation of the physiological strain rate.

15. A system in accordance with claim 11, wherein the monitoring device is configured to have information on the presence of a breathing gas cooler and on the cooling capacity thereof ready in a stored form and that the monitoring device is configured to include the information concerning breathing gas cooling in the calculation of the physiological strain rate.

16. A system in accordance with claim 1, wherein the monitoring device is integrated in the closed-circuit respirator and the closed-circuit respirator is configured to communicate the results of the monitoring device to the respirator user via visual, acoustic or tactile display units.

17. A system in accordance with claim 16, wherein the closed-circuit respirator is equipped with a radio transmission unit in order to be able to transmit the results of the monitoring device to a remotely located receiver.

18. A system in accordance with claim 1, wherein the monitoring device is a device, separate from the closed-circuit respirator and that the closed-circuit respirator is provided with a radio unit connected to the pressure sensor, with which the pressure values of the pressurized oxygen contained in the oxygen tank can be transmitted to the monitoring device.

19. A system in accordance with claim 18, wherein the monitoring device is provided with visual or acoustic display units in order to display the values determined by the monitoring device.
